(19) United States
(12) Patent Application Publication
(10) Pub. No.: US 2025/0018562 A1
(43) Pub. Date: Jan. 16, 2025

(54) ROBOTIC REASONING THROUGH PLANNING WITH LANGUAGE MODELS

(71) Applicant: GOOGLE LLC, Mountain View, CA (US)

(72) Inventors: Fei Xia, Sunnyvale, CA (US); Harris Chan, Toronto (CA); Brian Ichter, Brooklyn, NY (US); Wenlong Huang, Sunnyvale, CA (US); Ted Xiao, South San Francisco, CA (US); Karol Hausman, San Francisco, CA (US)

(21) Appl. No.: 18/359,550

(22) Filed: Jul. 26, 2023

Related U.S. Application Data
(60) Provisional application No. 63/526,366, filed on Jul. 12, 2023.

(51) Int. Cl. B25J 9/16; B25J 13/00; B25J 13/08; B25J 19/02; G06F 40/40

(52) U.S. Cl. CPC B25J 9/163; B25J 9/1653; B25J 13/003; B25J 13/085; B25J 19/023; G06F 40/40

(57) ABSTRACT

Some implementations related to using a large language model (LLM) in generating (and potentially refining) a plan for the execution of a long-horizon robotic task. Various implementations include processing, using the LLM, a free-form natural language instruction and textual feedback to generate LLM output. In many implementations, the free-form natural language instruction describes the robotic task. In additional or alternative implementations, the textual feedback can include task-specific feedback, passive scene description feedback, active scene description feedback, one or more additional or alternative types of environmental feedback, and/or combinations thereof. In some implementations, the system can select one or more robotic skills to perform based on the LLM output.

### BACKGROUND

Many robots are programmed to perform certain tasks. For example, a robot on an assembly line can be programmed to recognize certain objects, and perform particular manipulations to those certain objects.

Further, some robots can perform certain tasks in response to explicit user interface input that corresponds to the certain task. For example, a vacuuming robot can perform a general vacuuming task in response to a spoken utterance of “robot, clean”. However, often, user interface inputs that cause a robot to perform a certain task must be mapped explicitly to the task. Accordingly, a robot can be unable to perform certain tasks in response to various free-form natural language inputs of a user attempting to control the robot.

### SUMMARY

Implementations described herein are directed towards processing (1) free-form natural language instructions for a robot to perform a long-horizon robotic task and (2) textual feedback, using a large language model (LLM) in generating, and at least selectively refining, a plan for the execution of the long-horizon robotic task. In some implementations, the LLM can process the natural language instruction and the textual feedback to generate LLM output. In some of those implementations, the LLM output can reflect natural language that indicates one or more sub-tasks to perform a task (e.g., the task indicated in the natural language instruction). Additionally or alternatively, in some implementations the LLM can act as an interactive problem solver by incorporating embodied environment observations into grounded planning through a process referred to herein as “Inner Monologue”.

In some implementations, the large language model used in generating the LLM output can be a model (e.g., a neural network model) that has been trained on a large amount of sequential data to enable utilization of the trained model in processing a sequence of input data to generate output that predicts one or more additional sequences in dependence on the sequence of input data. The sequential data can include a variety of types of data, such as text data, number data, image data, video data, audio data, other type(s) of data, and/or combinations thereof. While implementations of LLMs are described herein with respect to a neural network model having a transformer architecture, this is merely illustrative of some implementations and is not meant to be limiting. For example, some LLMs can utilize additional or alternative network architectures. Additionally or alternatively, a variety of implementations can use one or more additional models in processing input to generate the LLM output including, but not limited to, one or more models that are derived from a large language model.

Language has been shown to help humans internalize knowledge and perform complex reasoning through thinking in language. For example, when a person tries to solve a task, their inner monologue may include: “I have to unlock the door; let me try to pick up the key and put it in the lock . . . no, wait, it doesn't fit, I'll try another one . . . that one worked, now I can turn the key.” The thought process involves choices about the best immediate action to solve the high level task (e.g., “pick up the key”), observations about the outcomes of attempted actions (e.g., “it doesn't fit”), and corrective actions that are taken in response to these observations (e.g., “I'll try another one”). In some implementations, the system can use a LLM in generating an inner monologue for a robot.

In some implementations, textual feedback can include a variety of types of environmental feedback expressed through language. For example, the textual feedback can include task-specific feedback, passive scene description feedback, active scene description feedback, one or more additional or alternative types of environmental feedback, and/or combinations thereof.

Task specific feedback can include an indication of whether one or more actions were successfully performed by the robot. In some implementations, the LLM can be used to generate output indicating the robot should perform a skill to pick up an object (e.g., the LLM output “pick up the soda can” can indicate the robot should perform a grasping skill). One or more instances of sensor data, such as one or more instances of vision data captured by one or more vision sensors of the robot, can be processed using a success detection model to generate output indicating whether the robot successfully grasped the object (e.g., generating output indicating the task specific feedback of “not successful” or “successful”). For example, if the robot unsuccessfully attempts to grasp the soda can, the system can generate the task specific textual feedback of “not successful”. Similarly, if the robot successfully grasps the soda can, the system can generate the task specific textual feedback of “successful”.

Passive scene description feedback can broadly describe sources of scene feedback that are consistently provided to the LLM. Additionally or alternatively, passive scene description feedback can have a defined textual structure. In some implementations, passive scene description feedback can include a list of objects in the environment of the robot, such as a list of objects generated by processing one or more instances of vision data capturing the environment of the robot using an object detector model. For example, instance(s) of vision data capturing a table with a can of soda, a candy bar, and a banana can be processed using the object detector. Passive scene description feedback of “soda can, candy bar, banana” can be generated based on the output of the object detector. In some implementations, passive scene description feedback can be provided to the LLM automatically.

Active scene description feedback can include unstructured textual answers that are provided in response to open ended queries made by the LLM. In some implementations, a human operator can provide the unstructured textual answer. In some other implementations, the unstructured textual answer can be provided by an additional neural network model, such as a Visual Question Answering model. For example, subsequent to the robot successfully completing the action of navigating to a set of drawers, the LLM can ask the question “is the drawer open?”. In some implementations, a human operator, based on one or more instances of vision data capturing the environment of the robot, can provide the answer “The drawer is closed”.

In some implementations, the system can use a combination of types of textual feedback. For instance, a system can use task specific feedback and passive scene description feedback; a system can use task specific feedback and active scene description feedback; a system can use passive scene description feedback and active scene description feedback; and a system can use task specific feedback, passive scene description feedback. These combinations of types of textual feedback are merely illustrative, and some implementations can include additional and/or alternative combinations of textual feedback.

In some implementations, the free-form natural language instruction can indicate one or more long-horizon tasks for the robot to perform (or attempt to perform). The natural language instruction can include a variety of long-horizon task(s) for the robot including manipulation tasks, navigation tasks, one or more additional or alternative tasks, and/or combinations thereof. For example, a human operator can provide the natural language instruction of “move all the blocks into mismatching bowls.”. In some implementations, the long-horizon task can be broken into a sequence of sub-tasks. For example, the task of “move all the blocks into mismatching bowls” is a long-horizon task that can be broken down into a sequence of sub-tasks.

Accordingly, various implementations set forth techniques for internalizing knowledge and/or performing complex reasoning thinking in language by a robot. In some implementations, a human operator can guide the robot with free-form natural language instructions indicating a task for the robot. Free-form natural language instructions can allow a human operator to more easily control the robot when compared with the human operator selecting from a defined list of instructions. Additionally or alternatively, the human operator can easily offer free-form natural language feedback to the robot. In some implementations, the free-form natural language instruction(s) and textual feedback from the environment of the robot can be processed using an LLM to generate output, where the LLM acts as interactive problem solver by incorporating environment observations into grounded planning. As such, the robot can perform complicated tasks using an inner monologue for complex reasoning, where the same robot would not otherwise be able to perform the instruction without using the LLM.

The above description is provided as an overview of only some implementations disclosed herein. These and other implementations are described in more detail herein, including in the detailed description and the claims.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example of a human providing a free-form (FF) natural language (NL) instruction to an example robot.

FIG. 2 illustrates a simplified birds-eye view of an example environment in which the human and the robot of FIG. 1 are located, and illustrates an example vision data instance capturing the environment.

FIG. 3A illustrates an example of processing a free-form natural language instruction and textual feedback to select a robotic skill in accordance with various implementations disclosed herein.

FIG. 3B illustrates an example of processing the free-form natural language instruction of FIG. 3A and updated textual feedback in selecting an additional robotic skill in accordance with various implementations disclosed herein.

FIG. 4A illustrates an example of processing a free-form natural language instruction and textual task specific feedback to generate LLM output in accordance with various implementations disclosed herein.

FIG. 4B illustrates an example of processing a free-form natural language instruction and textual scene description feedback to generate LLM output in accordance with various implementations disclosed herein.

FIG. 4C illustrates an example of processing a free-form natural language instruction and unstructured textual answers to open ended textual questions generated by the LLM in accordance with various implementations disclosed herein.

FIG. 5 is a flowchart illustrating an example process in accordance with various implementations disclosed herein.

FIG. 6 schematically depicts an example architecture of a robot.

FIG. 7 schematically depicts an example architecture of a computer system.

### DETAILED DESCRIPTION

In some implementations, the reasoning capabilities of Large Language Models (LLMs) can be applied to domains beyond natural language processing, such as planning and interaction for robots. These embodied problems may require an agent to understand many semantic aspects of the world: the repertoire of skills available, how these skills influence the world, and/or how changes to the world (or environment of the robot) map back to the language. LLMs planning in embodied environments may need to consider not just what skills to do, but also how and when to do them—answers that can change over time in response to the agent's own choices. Implementations described herein may investigate to what extent LLMs used in such embodied contexts can reason over sources of feedback provided through natural language, without any additional training.

In some implementations, by leveraging environment feedback, LLMs can be used to form an inner monologue that allows them to more richly process and plan in robotic control scenarios. In some of those implementations, a variety of sources of feedback can be used, such as success detection, scene description, human interaction, one or more additional or alternative sources of feedback, and/or combinations thereof. In some implementations, closed-loop language feedback can significantly improve high-level instruction completion on many domains, including (but not limited to) simulated and/or real table top rearrangement tasks and/or long-horizon mobile manipulation tasks in a kitchen environment in the real world.

Intelligent and/or flexible embodied interaction may require robots to be able to deploy large repertoires of basic behaviors in appropriate ways, sequence these behaviors as needed for long horizon tasks, and/or recognize when to switch to a different approach if a particular behavior or plan is unsuccessful. High-level planning, perceptual feedback, and/or low-level control are just a few of the sub-tasks that may need to be seamlessly combined together to perform the sort of reasoning required for an embodied agent (such as a robot), to intelligently act in the world. While conventionally these challenges have been approached from the perspective of planning (e.g., TAMP, hierarchical learning, etc.), effective high-level reasoning about complex tasks also requires semantic knowledge and understanding of the world.

In many implementations, large language models (LLMs) can not only generate fluent textual descriptions, but also appear to have rich internalized knowledge about the world. When appropriately conditioned (e.g., prompted), an LLM can even carry out some degree of deduction and respond to questions that appear to require reasoning and inference. This raises an intriguing possibility: beyond their ability to interpret natural language instructions, language models in accordance with some implementations can further serve as reasoning models that combine multiple sources of feedback and/or become interactive problem solvers for embodied tasks, such as robotic manipulation.

Prior studies show that language helps humans internalize knowledge and perform complex relational reasoning through thinking in language. Imagine the “inner monologue” that happens when a person tries to solve some task: “I have to unlock the door; let me try to pick up the key and put it in the lock . . . no, wait, it doesn't fit, I'll try another one . . . that one worked, now I can turn the key.” The thought process in this case involves choices about the best immediate action to solve the high-level task (“pick up the key”), observations about the outcomes of attempted actions (“it doesn't fit”), and corrective actions that are taken in response to these observations (“I'll try another one”). Implementations described herein are directed towards such an inner monologue that is a natural framework for incorporating feedback for LLMs.

In some implementations, LLMs can be combined with various sources of textual feedback. In some of those implementations, the system may utilize few-shot prompting without any additional training. Natural language can provide a universal and/or interpretable interface for such grounding of model communication. Additionally or alternatively, natural language can allow the LLM to incorporate their conclusion(s) in an overarching inner monologue driven by a language model. Prior work has investigated using language models as planners or incorporating multimodal-informed perception through language. Conversely, various implementations described herein include the link of not only planning with language, but also informing embodied feedback with language.

Specifically, method(s) and/or source(s) of feedback can be used for closing the agent-environment loop via an inner monologue. Additionally or alternatively, some implementations include the impact of a variety of feedback and/or new capabilities arising from such interaction(s). In some implementations, multiple perception models can be combined, where the multiple perception models perform various tasks, such as (but not limited to) language-conditioned semantic classification and/or language-based scene description, together with feedback provided by a human user that the robot is cooperating with. To execute the commands given by a user, the actions are chosen from a set of pre-trained robotic manipulation skills together with their textual descriptions that can be invoked by a language model. Some implementations chain together one or more of these various components (perception models, robotic skills, human feedback, one or more additional or alternative components, and/or combinations thereof) in a shared language prompt, enabling the robot to successfully perform user instructions.

In some implementations, Inner Monologue, without requiring additional training beyond a frozen language model and pre-trained robotic skills, can accomplish complex, long-horizon, and unseen tasks in simulation as well as on real-world robotic platforms. In some of those implementations, it can be shown that the system can efficiently retry under observed stochastic failure, replan under systematic infeasibility, and/or request human feedback for ambiguous queries, which can result in significantly improved performance in dynamical environments. Additionally or alternatively, the inner monologue formulation can show continued adaptation to new instructions, self-proposed goals, interactive scene understanding, multilingual interactions, and more.

Task and/or motion planning can require simultaneously solving a high-level, discrete task planning problem, and a low-level, continuous motion planning problem. Traditionally, this problem has been solved through optimization, or symbolic reasoning, but more recently machine learning has been applied to aspects of the problem via learned representations, learned task-primitives, and more. Some techniques can utilize language for planning and grounding. Others have approached the problem through hierarchical learning. In many implementations described herein, the system can leverage pre-trained LLMs and their semantic knowledge, along with trained low-level skills, to find feasible plans.

Various prior works have explored using language as a space for planning. For example, task planning approaches can leverage pre-trained autoregressive LLMs to decompose abstract, high-level instructions into a sequence of low-level steps executable by an agent in a zero-shot manner. A variety of approaches can effectively produce an action plan while assuming that each proposed step is executed successfully by the agent. As a result, these approaches may not be robust in handling intermediate failures in dynamic environments or with poor lower level policies. In some implementations, the Inner Monologue system can incorporate grounded feedback from the environment into the LLM as the system produces each step in the plan.

Various works have investigated strategies for the challenging problem of fusing vision, language, and control. While pretrained LLMs typically train only on text data, pretrained visual-language models (e.g., CLIP) are trained on joint image(s) and corresponding text captions via variants of masked language modeling (MLM) objective, contrastive loss, and/or or other supervised objectives. CLIP has been employed in several robotics and embodied settings in zero-shot manner, or combined with Transporter networks as in CLIPort. Socratic Models can combine several foundation models (e.g., PaLM, VILD, etc.) and language-conditioned policies, using language as the common interface, and demonstrating manipulating objects in a simulated vision-based robotic manipulation environment.

In some implementations, LLMs can act as interactive problem solvers and incorporate embodied environment observations into grounded planning through a process referred to herein as Inner Monologue. For example, the system can include an embodied robotic agent attempting to perform a high-level natural language instruction i. This robotic agent is capable of executing short-horizon skills from a library of previously trained policies πₖ∈Π with short language descriptions lₖ, which may be trained with reinforcement learning or behavioral cloning. The “planner,” which is a pre-trained LLM, attempts to find a sequence of skills to accomplish the instruction. To observe the environment, the planner has access to textual feedback from the environment that can be appended to the instruction or requested by the planner. The observation may be success detection, object detection, scene description, visual-question answering, or even human feedback. In some implementations, the LLM planner is able to reason over and utilize such feedback to “close the loop” with the environment and improve planning.

In some implementations, the system can formulate an “inner monologue” by continually injecting information from the various sources of feedback into the LLM planning language prompts as the robot interacts with the environment. While LLMs have demonstrated exceptional planning capabilities for embodied control tasks, prior techniques have found it crucial to ground LLM predictions with external components such as affordance functions in order to produce useful plans that are executable by robots. However, LLMs used in this context have thus far remained one-directional—providing a list of skills, without making corrections or leveraging opportunities to replan accordingly. In contrast, Inner Monologue can include settings where grounded environment feedback is provided directly to the LLM in a closed-loop fashion. In some implementations, this can promote improved LLM reasoning in complex long-horizon settings, often times before any external affordance-based grounding methods are applied.

In some implementations, the system can assume textual feedback is provided to the planner, but does not assume a single specific method of fusing LLM planning with low-level robotic control and/or a specific method of extracting environment feedback into language. Rather than focusing on a particular algorithmic implementation, the aim is to provide a case study on the value of incorporating different types of feedback into closed-loop LLM-based planning. Thus, Inner Monologue techniques described herein can use language feedback within separate systems that incorporate different LLMs, different methods of fusing planning with control, different environments and tasks, and/or different methods of acquiring control policies. It should be noted that in some implementations of Inner Monologue, the system can use pre-trained LLMs for planning that are not fine-tuned, but rather evaluated solely with few-shot prompting.

A variety of types of environment feedback can inform the LLM planner, as long as it can be expressed through language. In some implementations, focus is on the specific forms of feedback which can include task-specific feedback (such as success detection), and scene-specific feedback (either “passive” or “active”), which describes the scene.

Semantic success detection can be a binary classification problem of whether the low-level skill πₖ has succeeded. In some implementations, engineered success detectors can operate on ground-truth state in simulation. Additionally or alternatively, learned success detectors can be trained on real examples of successes and failures in the real world. In some implementations, the system can use the output of one or more success detectors in language form (which is referred to herein as success feedback).

While there are many ways to describe the semantics contained within a scene, the term “Passive Scene Description” is used herein to broadly describe sources of scene feedback that are consistently provided and follow some structure. Passive Scene Description covers all sources of environment grounding feedback that are automatically provided and injected into the LLM prompt without any active prompting or querying by the LLM planner. In some implementations, passive scene description feedback can include object recognition. The textual output(s) of such object recognizers is referred to herein as object feedback. Additionally or alternatively, the use of a task-progress scene description can be referred to herein as scene feedback.

As the proactive counterpart to Passive Scene Description, Active Scene Description can encompass sources of feedback that are provided directly in response to active queries by the LLM planner. In some implementations, the LLM can directly ask a question about the scene. In some of those implementations, this question can be answered by a person and/or by another pretrained model, such as a Visual Question Answering (VQA) model. While the task specific feedback and passive scene description feedback are structured and narrow in their scope, in the Active Scene Description setting the LLM can receive unstructured answers to open-ended questions, allowing it to actively gather information relevant to the scene, the task, and/or even preferences of the user (in the case of human-provided response). In some implementations, the LLM-generated question can be combined with the response as additional feedback which can be provided to the LLM. In some implementations, the system can incorporate VQA-style human feedback and as unstructured human preferences feedback. Human feedback as described herein refers to human-provided responses.

In some implementations, using one or more sources of environment feedback can support a rich inner monologue. In some of those implementations, the system can be used for complex robotic control for a variety of long-horizon manipulation and/or navigation tasks. Additionally or alternatively, the system can be used in simulated environments and/or real world environments. As Inner Monologue techniques described herein are not dependent on a specific LLM or a type of grounding feedback, a variety of implementations can be used in various environments with different LLM planning methods and/or different sources of feedback from the environment. For example, the system can be used in a simulated tabletop manipulation environment, a real tabletop manipulation environment, a real mobile manipulation environment, one or more additional or alternative environments, and/or combinations thereof.

In some implementations, the system can be used with vision-based block manipulation tasks (e.g., in a Ravens-based simulation environment). Given a number of blocks and bowls on a table, a robotic arm containing a gripper is tasked with rearranging these objects in some desired configuration, specified by natural language (e.g., “putting the blocks in the bowls with matching colors”). In some implementations, the system can be evaluated on four seen tasks and four unseen tasks, where seen tasks may be used for training and/or used as few-shot prompting for LLM planner.

In some implementations, the system can use (i) an LLM for multi-step planning, (ii) scripted modules to provide language feedback in the form of object recognition (Object), success detection (Success), and task-progress scene description (Scene), and (iii) a pre-trained language-conditioned pick-and-place primitive (e.g., CLIPort and/or Transporter Nets). In some implementations, Object feedback can inform the LLM planner about the objects present in the scene. In some of those implementations, the system can use only Object feedback. Additionally or alternatively, Success feedback can inform the planner about success/failure of one or more recent actions (e.g., the success/failure of the most recent action). However, in the presence of many objects and test-time disturbances, the complex combinatorial state space requires the planner to additionally reason about the overall task progress (e.g., if the goal is to stack multiple blocks, the unfinished tower of blocks may be knocked over by the robot). In some implementations, task-progress scene description (Scene) can describe one or more semantic sub-goals inferred by the LLM towards completing the high-level instruction that are achieved by the agent so far. In some implementations, the system can use Object+Scene feedback. In some of those implementations, due to the additional reasoning complexity, adding chain-of-thought can improve the consistency between inferred goals and achieved goals.

In some implementations, the system can use a multi-task CLIPort policy directly trained on long-horizon task instructions (i.e., without using LLM for planning). In some of those implementations, CLIPort is a single-step policy and does not terminate spontaneously during policy rollout, CLIPort evaluations can be used with oracle termination (i.e., repeat until oracle indicates task completion) and fixed-step termination (i.e., repeat for k steps). In some implementations, the Inner Monologue terminates when the LLM stops generating new steps. In some implementations, the maximum number of steps can be set to be k for practical considerations. In some of those implementations, the system can use k=15. However, this is merely illustrative, and the maximum number of steps can be set to additional or alternative values. In some implementations, real-world disturbances can be simulated by adding Gaussian noise to multiple levels of the system (e.g., to evaluate the system's robustness to distances).

In some implementations, the system can perform well on seen tasks. Additionally or alternatively, the system can leverage rich semantic knowledge in the pre-trained LLM, which can be translated to unseen tasks without further training. In some implementations, the system using Object+Scene performs the best because of its ability to keep track of all goal conditions and/or currently achieved goals.

In some implementations, the system can be used in a real-world robot platform designed to resemble the simulation described above, using motion primitives for tabletop pick and place. The setup can include a UR5e robot arm equipped with a wrist-mounted RGB-D camera overlooking a workspace of diverse objects—from toy blocks to food items to condiments. Some of those implementations can include (i) an LLM for multi-step planning, (ii) a pre trained open-vocabulary object recognition with MDETR to generate a list of currently visible objects and list of previously visible objects that are no longer visible (Object), (iii) heuristics on the object bounding box predictions from MDETR for Success Detection (Success), and/or (iv) a zero-shot pick and place policy that uses an LLM to parse target objects from a language command (e.g., given by the planner) and then executes scripted suction-based picking and placing primitives at the center of the target objects' bounding boxes. Aside from the pretraining of the LLM and MDETR (which are available out-of-the-box), the system does not require any model fine tuning to perform pick and place tasks with new objects.

The real-world tabletop rearrangement can include a variety of tasks, including (i) a simple 3-block stacking task where 2 blocks are already pre-stacked, and (ii) a more complex long-horizon sorting task to place food in one plate and condiments in another (where categorizing food versus condiments is autonomously done by the LLM planner). Since default pick and place performance is generally quite high on the system, Gaussian noise can be injected into the policy actions (i.e., add standard deviation σ=4 mm clipped at 2σ to stress test recovery from failures via replanning with grounded closed-loop feedback. Note that the system may also be subject to noisy object and/or success detections due to the additional challenge of real-world perception and clutter.

In some implementations, the system can use different variants of LLM-informed closed-loop feedback, as well as an open-loop variant that only runs object recognition once at the beginning of the task. For example, the partial 3-block stacking task highlights an immediate failure mode of this baseline, where the initial scene description struggles to capture a complete representation of the scene (due to clutter and occlusion) to provide as input to the multi-step planner. As a result, the system only executes one pick and place action—and cannot recover from mistakes. To address these shortcomings, Inner Monologue (Object+Success) leverages closed-loop scene description and success detection after each step, which allows it to successfully replan and recover from policy mistakes.

Additional ablations with Inner Monologue also show that (i) common failures induced by lack of closed-loop scene description are largely due to initially occluded objects not being part of the LLM generated plans, and (ii) failures induced by lack of success detection come from not retrying pick and place actions that have failed due to policy noise. Overall, both components can be complementary and important in maintaining robust recovery modes for real rearrangement tasks.

In some implementations, the system can be used with a real-world mobile manipulator in a kitchen setting. For example, a robotic system using the kitchen environment and task definitions described in SayCan can be used. A robot with a mobile manipulator with RGB observations, can be placed in an office kitchen to interact with common objects using concurrent and/or continuous closed-loop control.

The baseline, SayCan, is a method that plans and acts in diverse real world scenarios by combining an LLM with value functions of underlying control policies. While SayCan creates plans that are grounded by the affordances of value functions, the LLM predictions in isolation are never given any closed-loop feedback.

In some implementations, the system can use (i) PALM as the LLM for multi-step planning, (ii) value functions from pre-trained control policies for affordance grounding, (iii) a learned visual classification model for success detection feedback (Success), (iv) human-provided object recognition feedback (Object), and (v) pre-trained control policies for relevant skills in the scene. Additionally or alternatively, the robotic agent can ask questions and source Human feedback directly. In some implementations, the system can be evaluated on 120 evaluations over three task families: 1) four manipulation tasks, 2) two dexterous manipulation tasks utilizing drawers, and 3) two long-horizon combined manipulation and navigation tasks. In order to better study how Inner Monologue improves reasoning in especially challenging scenarios, an experiment variant can be considered where adversarial disturbances are added during control policy executions that cause skill policy rollouts to fail. These disturbances may be fairly simple and just require the policy to try again, or these disturbances may be complex enough that the policy needs to replan and select a completely new skill. While these failures occur naturally even without perturbances, the adversarial disturbances create a consistent comparison between methods that requires retrying or replanning to accomplish the original instruction.

Without adversarial disturbances, the baseline method SayCan performs reasonably on all three task families, yet incorporating LLM-informed feedback on skill success/failure and presence of objects allows the Inner Monologue to effectively retry or replan under natural failures, providing further improvement to the baseline. The most notable difference is in the cases with adversarial disturbances when a policy failure is forced to occur. Without any LLM-informed feedback, SayCan has a success rate close to 0% since it does not have explicitly high-level retry behavior. In contrast, Inner Monologue can significantly outperform SayCan because of its ability to invoke appropriate recovery modes depending on the environment feedback. In-depth analysis on the failure causes indicates that Success and Object feedback can effectively reduce LLM planning failures and thus overall failure rate, albeit at the cost of introducing new failure modes to the system.

Although LLMs can generate fluent continuation from the prompted examples, when informed with environment feedback, Inner Monologue demonstrates many impressive reasoning and/or replanning behaviors beyond the examples given in the prompt. Using a pre-trained LLM as the backbone, the method also inherits many of the appealing properties from its versatility and general-purpose language understanding.

In some implementations, the system shows continued adaptation to new instructions. Although not explicitly prompted, the LLM planner can react to human interaction that changes the high-level goal mid-task. For example, a human operator can provide the free-form natural language instruction of “throw away the snack on the close counter”. After navigating to the table, the robot can ask the human “what snacks are on the counter?”. The human operator can subsequently change the goal by saying “actually I changed my mind. I want you to throw away something on the table.” The robot can then prompt the human operator “What snacks are on the table?”, to which the human operator can respond “Nevermind I want you to finish your previous task”. In other words, Human feedback can indicate a change in the goal during the plan execution, and then indicate another change in the goal when the human operator instructs to “finish the previous task”. In some implementations, the planner incorporates the feedback correctly by switching tasks twice. In some other implementations, despite not being explicitly prompted to terminate after a human says “please stop”, the LLM planner generalizes to this scenario and predicts a “done” action.

In some implementations, the system can self propose goals under infeasibility. Instead of mindlessly following human-given instructions, Inner Monologue can also act as an interactive problem solver by proposing alternative goals to achieve when the previous goal becomes infeasible. For example, the human operator can provide the free-form natural language instruction of “put any two blocks inside the purple bowl”, where the scene description includes “There is a purple bowl, red block, purple block, blue block, orange bowl, orange block”. The system can first attempt an action of picking up the purple block—the action fails as the purple block is intentionally made to be too heavy for the robot. After a hint “the purple block is too heavy”, the system can propose to “find a lighter block” and successfully solve the task in the end.

In some implementations, the system can be used in a multilingual interaction. Pre-trained LLMs are known to be able to translate from one language to another, without any finetuning. In some implementations, such multilingual understanding also transfers to the embodied settings described herein. For example, the human operator can initially provide an instruction in English of “Put the blocks in the bowls with mismatching colors.” Subsequently, the human operator can provide new instruction in Chinese, but the LLM can correctly interpret it, re-narrate it as a concrete goal to execute in English, and accordingly replan its future actions. In some implementations, this capability can extend to symbols and/or emojis.

In some implementations, the system can include interactive scene understanding. Inner Monologue demonstrates interactive understanding of the scene using the past actions and environment feedback as context. For example, the human operator can provide the free-form natural language instruction of “Put any two blocks inside the purple bowl” for a scene which can be described as “There is a purple bowl, red block, purple block, blue block, orange bowl, orange block”. After the task has been completed by the robot, the human operator can ask questions about the scene, again a structure that has not appeared in the prompt. For example, the human operator can ask “What objects are in the purple bowl?” In some implementations, the system can answer these questions that require temporal and embodied reasoning.

In some implementations, the system can include robustness to feedback order. In general, the LLM can be prompted with natural language instructions that follow certain conventions. For example, in the simulated tabletop domain, the convention can be [Robot action, Scene, and Robot thought]. However, the LLM planner is robust to occasionally swapping the order of feedback. For example, a new human instruction of “I changed my mind. Can you put all the blocks in the red bowl?” can be injected in the middle of the plan execution, where this structure has not been seen in the example prompts. In some of those implementations, the planner can recognize the change and generates a new “Robot thought: Goal state is . . . ” statement allowing it to solve the new task.

In some implementations, the system can be robust to typos. Inherited from the LLM backbone, some implementations described herein are robust to typos in human instruction. For example, a human operator can provide the instruction of “Actully, can you put the bloks in the maching bwls?” In some implementations, despite the typographical errors in the free-form natural language instruction, the robot can generate the thought “Goal state is [” Yellow block is in the yellow bowl.”, “Blue block is in the blue bowl”].

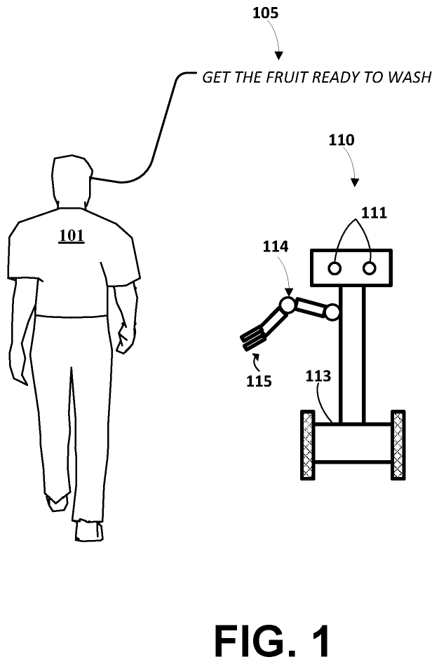

Turning now to the figures, FIG. 1 illustrates an example of a human 101 providing a free-form (FF) natural language (NL) instruction 105 of “get the fruit ready to wash” to an example robot 110. The robot 110 illustrated in FIG. 1 is a particular mobile robot. However, additional and/or alternative robots can be utilized with techniques disclosed herein, such as additional robots that vary in one or more respects from robot 110 illustrated in FIG. 1. For example, a mobile forklift robot, an unmanned aerial vehicle (“UAV”), a non-mobile robot, and/or a humanoid robot can be utilized instead of or in addition to robot 110, in techniques described herein.

Robot 110 includes a base 113 with wheels provided on opposed sides thereof for locomotion of the robot 110. The base 113 may include, for example, one or more motors for driving the wheels of the robot 110 to achieve a desired direction, velocity, and/or acceleration of movement for the robot 110. The robot 110 also includes robot arm 114 with an end effector 115 that takes the form of a gripper with two opposing “fingers” or “digits.”

Robot 110 also includes a vision component 111 that can generate vision data (e.g., images) related to shape, color, depth, and/or other features of object(s) that are in the line of sight of the vision component 111. The vision component 111 can be, for example, a monocular camera, a stereographic camera (active or passive), and/or a 3D laser scanner. A 3D laser scanner can include one or more lasers that emit light and one or more sensors that collect data related to reflections of the emitted light. The 3D laser scanner can generate vision component data that is a 3D point cloud with each of the points of the 3D point cloud defining a position of a point of a surface in 3D space. A monocular camera can include a single sensor (e.g., a charge-coupled device (CCD)), and generate, based on physical properties sensed by the sensor, images that each includes a plurality of data points defining color values and/or grayscale values. For instance, the monocular camera can generate images that include red, blue, and/or green channels. Each channel can define a value for each of a plurality of pixels of the image such as a value from 0 to 255 for each of the pixels of the image. A stereographic camera can include two or more sensors, each at a different vantage point. In some of those implementations, the stereographic camera generates, based on characteristics sensed by the two sensors, images that each includes a plurality of data points defining depth values and color values and/or grayscale values. For example, the stereographic camera can generate images that include a depth channel and red, blue, and/or green channels.

Robot 110 also includes one or more processors that, for example: process FF NL input and map data to determine object descriptor(s) relevant to a robotic task of the FF NL input; determine, based on the FF NL input and the object descriptor(s), robotic skill(s) for performing the robotic task; control a robot, during performance of the robotic task, based on the determined robotic skill(s); etc. For example, one or more processors of robot 110 can implement all or aspects of process 500 described herein. Additional description of some examples of the structure and functionality of various robots is provided herein.

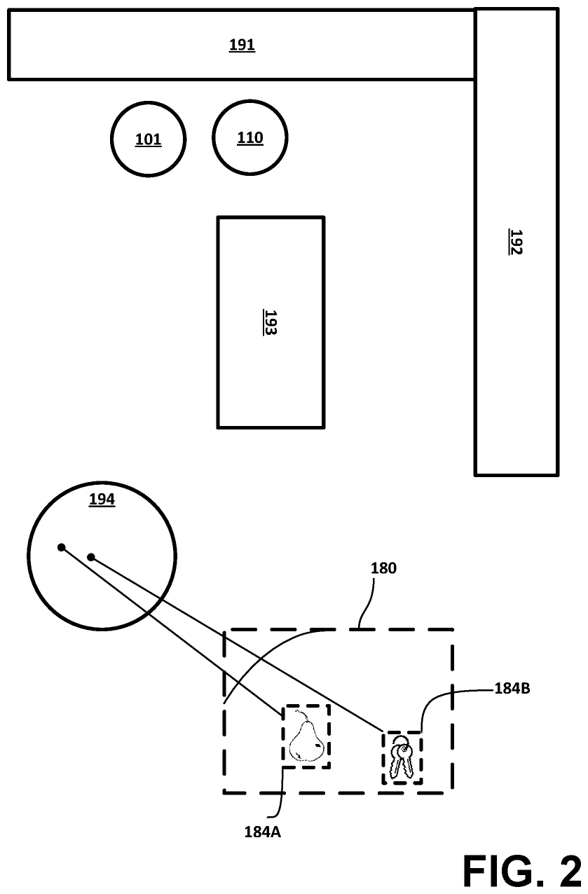

Turning now to FIG. 2, a simplified birds-eye view of an example environment, in which the human 101 and the robot 110 of FIG. 1 are located, is illustrated. The human 101 and the robot 110 are represented as circles in FIG. 2. Further, environmental features 191, 192, 193, and 194 are illustrated in FIG. 2. The environmental features 191, 192, 193, and 194 illustrate outlines of landmarks in the environment. For example, the environment could be an office kitchen or a work kitchen, and features 191 and 192 can be countertops, feature 193 can be a kitchen island, and feature 194 can be a round table.

Also illustrated in FIG. 2 is an example vision data instance 180 that was captured in the environment. For example, robot 110 may have captured the vision data instance 180, using vision component 111, during a previous exploration of the environment of FIG. 2. Additionally or alternatively, robot 110 may have captured the vision data instance 180, using vision component 111, subsequent to robot 110 performing one or more sub-tasks in the environment of FIG. 2. In the illustrated example, the vision data instance 180 captures a pear 184A and keys 184B that are both present on the round table represented by feature 194. It is noted that, in some implementations, the view of the pear, the keys, and other objects of the environment is illustrated as a birds-eye view for the sake of simplicity.

The instance of vision data 180 can be processed using one or more perception models to generate textual feedback, such as task specific textual feedback, passive scene description textual feedback, active scene description textual feedback, etc. In some implementations, the free-form natural language instruction 105 of “get the fruit ready to wash” and the textual feedback (e.g., textual feedback generated based on processing the instance of vision data 180) can be processed using a large language model (LLM) to generate LLM output dependent on the instruction. In some implementations, the LLM output can indicate at least a portion of the “inner monologue” of the robot, where the LLM output is generated based on the LLM acting as interactive problem solver by incorporating embodied environment observations into grounded planning. Only a single vision data instance is illustrated in FIG. 2 for sake of simplicity. However, it is noted that many additional vision data instances can be captured in the environment for utilization in techniques disclosed herein.

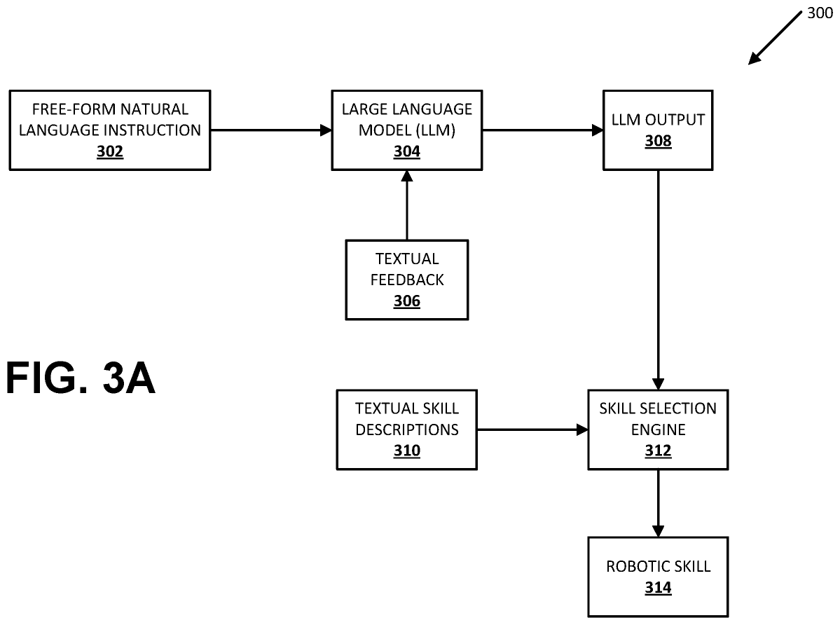

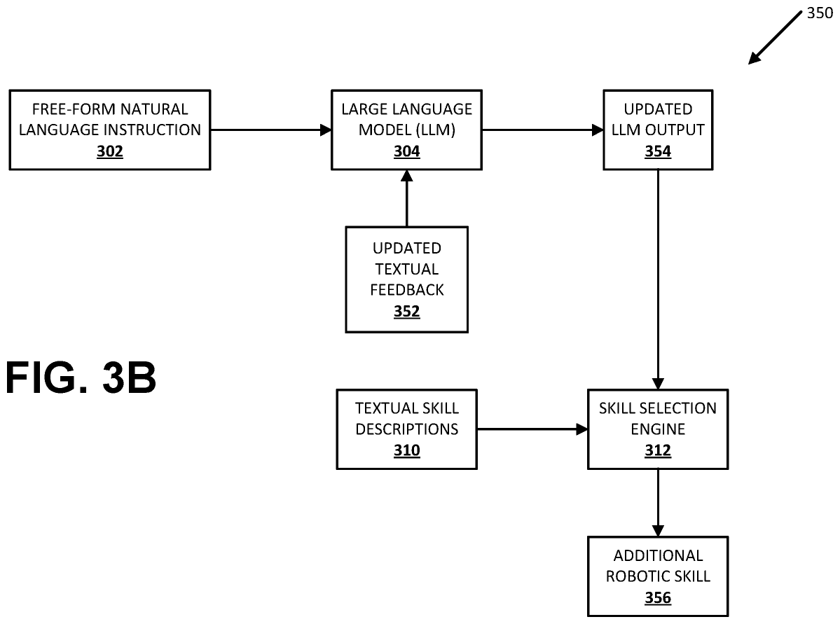

FIG. 3A illustrates an example of selecting a robotic skill based on a free-form natural language instruction. In the illustrated example 300, the system receives a free-form natural language instruction 302. In some implementations, the system can receive textual feedback 306. In some implementations, the textual feedback 306 can include a variety of types of textual feedback, such as, task specific feedback, passive scene description feedback, active scene description feedback, one or more additional or alternative types of environmental feedback, and/or combinations thereof. In some of those implementations, the textual feedback 306 can be output generated using one or more perception models.

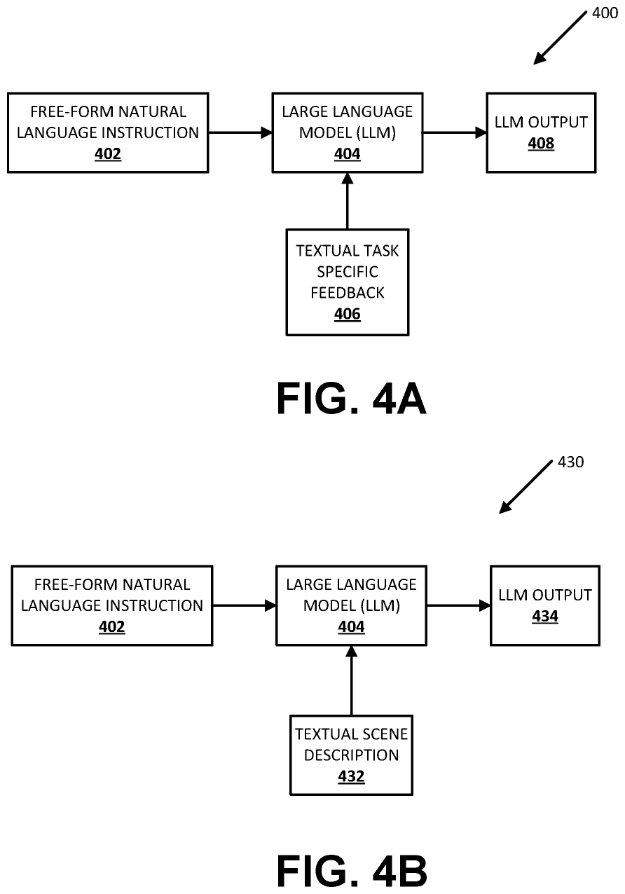

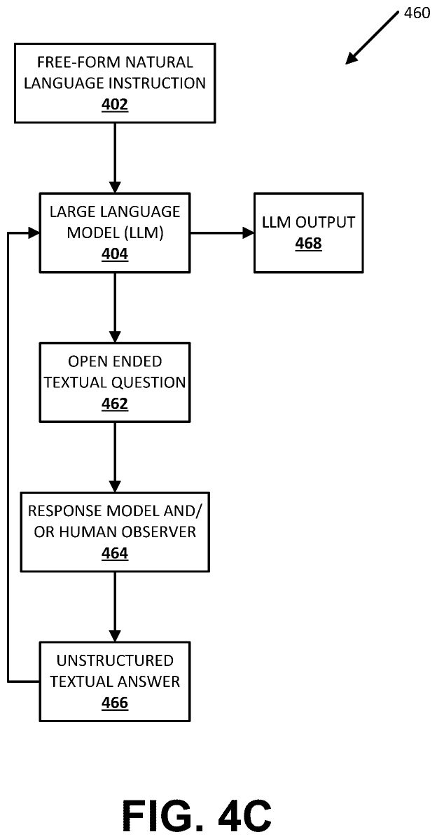

An example 400 of using textual task specific feedback is described herein with respect to FIG. 4A. Similarly, an example 430 of using passive scene description feedback is described herein with respect to FIG. 4B. Additionally or alternatively, an example 460 of using active scene description feedback is described herein with respect to FIG. 4C.

The free-form natural language instruction 302 and one or more instances of textual feedback 306 can be processed using a large language model (LLM) 304 to generate LLM output 308. In some implementations, the LLM output 308 can be textual output. In some implementations, the LLM output 308 can represent at least a portion of the inner monologue of the robot as described herein. In some implementations, the robot can be associated with a set of robotic skills that are performable by the robot. Each skill can have a corresponding policy network for performance of the skill and a textual description of the skill. In some implementations, one or more textual skill descriptions 310 and the LLM output 308 can be processed using skill selection engine 312 to select a robotic skill 314 for the robot to perform (or attempt to perform). In some implementations, the skill selection engine 312 can compare textual LLM output 308 with one or more of the textual skill descriptions 310. In some of those implementations, the skill selection engine 312 can select the robotic skill 314 based on the comparing.

FIG. 3B illustrates an example of selecting an additional robotic skill 356 based on the free form natural language instruction 302. In the illustrated example 350, the system identifies the free-form natural language instruction 302. In some implementations, the free-form natural language instruction 302 described herein with respect to FIG. 3B is the same instruction described above with respect to FIG. 3A. Additionally or alternatively, the system can identify one or more instances of updated textual feedback 352. In some implementations, the updated textual feedback 352 can reflect one or more changes in the environment of the robot. In some of those implementations, the updated textual feedback 352 can be based on the robot attempting to perform the robotic skill 314 selected above with respect to FIG. 3A.

In some implementations, the system can process the free-form natural language instruction 302 and the updated textual feedback 352 using the LLM 304 to generate updated LLM output 352. In some implementations, the updated LLM output 352 can be textual output. In some implementations, the updated LLM output 352 can represent at least a portion of the inner monologue of the robot as described herein. In some implementations, the system can process the updated LLM output 354 and the one or more textual skill descriptions 310 using the skill selection engine 312 to select an additional robotic skill 356 for the robot to perform (or attempt to perform). In some implementations, the skill selection engine 312 can compare textual LLM output 352 with one or more of the textual skill descriptions 310. In some of those implementations, the skill selection engine 312 can select the additional robotic skill 354 based on the comparing.

For example, the system can receive the free-form natural language instruction 302 of “Can you bring me a drink from the table?” from a human operator. Additionally or alternatively, the system can identify one or more instances of textual feedback 306 including a description of the environment that includes the table. The system can process the free-form natural language instruction 302 and the textual feedback 306 using the LLM 304 to generate LLM output 308 of “go to the table”. The system can compare the LLM output 308 with one or more textual skill descriptions 310 using the skill selection engine 312 to select a navigation robotic skill 314.

After the robot navigates to the table, the system can capture one or more instances of vision data capturing the objects on the table (e.g., capture one or more instances of vision data using one or more vision sensors). For example, the system can process the instance(s) of vision data capturing the table using an object detection model to generate updated textual feedback 352 of “I see: soda, water, chocolate bar”. In some implementations, the system can process the updated textual feedback 352 and the free-form natural language instruction 302 of “Can you bring me a drink from the table?” using the LLM 304 to generate updated LLM output 352.

In some implementations, the updated LLM output 352 can indicate multiple beverages on the table (e.g., the soda and the water), and the system can ask the human operator the question “Do you want water or soda?”. In response to the question generated using the LLM, the human operator can provide the answer of “Soda please”. In some implementations, the system can append the answer of “Soda please” to the question “Do you want water or soda?” as a further updated instance of textual feedback to provide to the LLM.

In some implementations, the system can process the free-form natural language instruction 302 of “Can you bring me a drink from the table?” and active scene description feedback of “Do you want water or soda?” and “Soda please” using the LLM 304 to generate further updated LLM output (not depicted) indicating the robot should grasp the soda. Additionally or alternatively, the system can use the skill selecting engine 312 to compare the further updated LLM output (not depicted) with the textual skill descriptions 310 to select a grasping skill.

The robot can attempt to grasp the soda. In some implementations, the system can determine the robot failed to successfully grasp the soda by processing one or more instances of vision data (e.g., instance(s) of vision data capturing the grasping end effector of the robot, where the grasping end effector has failed to pick up the soda) using a success detection model to generate textual output of “Action was not successful”. In some of those implementations, the system can process the textual output of “Action was not successful” along with the free-form natural language instruction of “Can you bring me the drink from the table?” using the LLM to generate LLM output of “Action: pick up the soda” indicating the robot should repeat the grasping skill.

In some implementations, the robot can repeat the grasping skill and can successfully pick up the soda. In some of those implementations, one or more instances of vision data capturing the robot grasping the soda can be processed using the success detection model to generate textual feedback of “Action was successful”. The system can process the textual feedback of “Action was successful” and the free-form natural language instruction to generate LLM output of “Action: bring it to you” indicating the robot should navigate to the human operator with the soda. The robot planning and interaction described in the example above is not meant to be limiting and is merely illustrative. The system can include additional or alternative action(s) and/or interaction(s) in accordance with many implementations.

FIG. 4A-4C are examples illustrating LLM output generated using textual feedback. FIG. 4A includes example 400 where the free-form natural language instruction 402 and textual task specific feedback 406 are processed using LLM 404 to generate LLM output 408. In some implementations, the textual task specific feedback 406 can include output generated using a success detection model indicating whether the robot successfully performed a skill. For example, one or more instances of vision data capturing the robot holding a soda can be processed using the success detection model to generate task specific output of “Success: True” indicating the robot successfully performed the action Pick up the soda. In some implementations, the free-form natural language instruction 402 of “Can you bring me a drink from the table” and the task specific output of “Success: True” can be processed using the LLM to generate LLM output indicating the robot should bring the soda to the human operator.

FIG. 4B includes example 430 where free-form natural language instruction 402 and textual scene description feedback 432 are processed using LLM 404 to generate LLM output 434. For example, one or more instances of vision data capturing a set of objects on a table can be processed using an object detection model to generate textual scene description feedback 432 of “Scene: lime soda, cola, energy bar”. In some implementations, the free-form natural language instruction 402 of “Can you bring me a snack” and the textual scene description feedback 432 of “Scene: lime soda, cola, energy bar” can be processed using the LLM 404 to generate LLM output 434 indicating the robot should pick up the energy bar.

FIG. 4C includes example 460 where free-form natural language instruction 402 and unstructured textual answers 466 are processed using LLM 404 to generate LLM output 468. For example, the LLM 404 can generate output indicating an open ended textual question 462, such as “Is the drawer open?”. In some implementations, the open ended textual question 462 can be transmitted to a human observer so the human observer can generate the unstructured textual answer to the question. Additionally or alternatively, the open ended textual question 462 can be processed using a neural network model (such as a Visual Question Answer model) to generate the unstructured textual answer to the question. For example, the human operator can respond to the open ended textual question 462 with the unstructured textual answer 466 of “The drawer is closed”. In some implementations, the unstructured textual answer 466 can be processed using the LLM 404 to generate additional LLM output (not depicted). Additionally or alternatively, the unstructured textual answer 466 and the open ended textual question 462 can be processed using the LLM 404 to generate additional LLM output (not depicted).

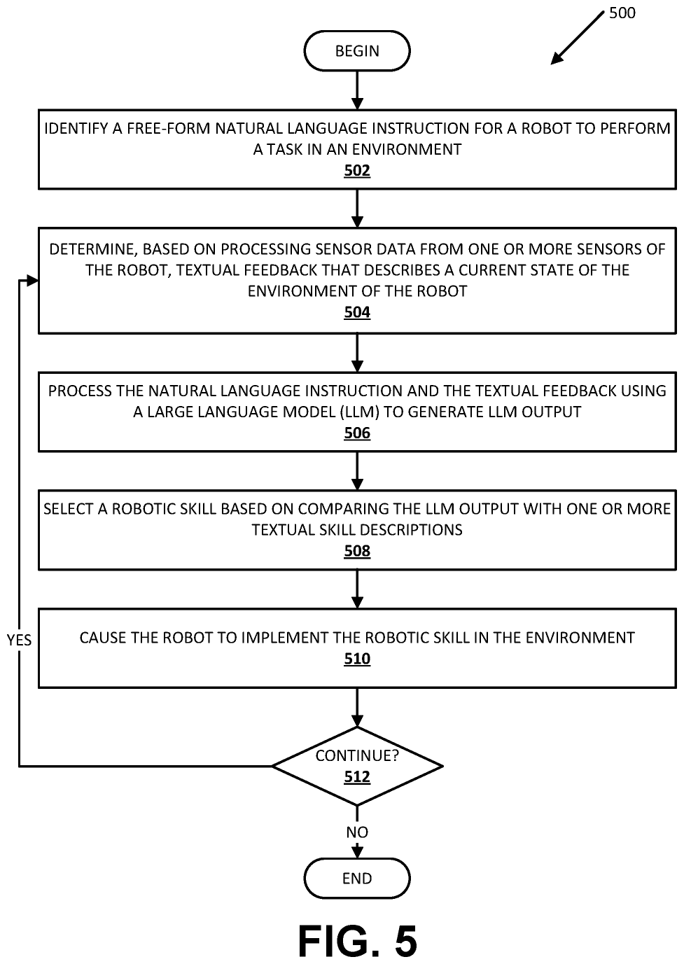

FIG. 5 is a flowchart illustrating an example process 500 of causing a robot to implement a robotic skill using a LLM in accordance with various implementations described herein. For convenience, the operations of the process 500 are described with reference to a system that performs the operations. This system can include one or more components of a robot, such as a robot processor and/or robot control system of robot 110, robot 620, and/or other robot and/or can include one or more components of a computer system, such as computer system 710. Moreover, while operations of process 500 are shown in a particular order, this is not meant to be limiting. One or more operations can be reordered, omitted or added.

At block 502, the system identifies a free-form natural language instruction for a robot to perform a task in an environment. In some implementations, the free-form natural language instruction can be provided by a human operator. In some other implementations, the free-form natural language instruction can be provided by an additional or alternative robot in the environment. For example, the system can identify the free-form natural language instruction of “move all the blocks into mismatched bowls” indicating a manipulating task. In some implementations, the robot is unable to implement the task by performing a single skill (e.g., the task is a long-horizon task and the skill is a short-horizon skill). In some implementations, the robot can implement one or more manipulation tasks, one or more navigation tasks, one or more additional or alternative tasks, and/or combinations thereof.

At block 504, the system determines, based on processing sensor data from one or more sensors of the robot, textual feedback that describes a current state of the environment of the robot. In some implementations the sensor data can be processed using one or more perception models to generate the textual feedback. Textual feedback can include task specific feedback, passive scene description feedback, active scene description feedback, one or more additional or alternative types of environmental feedback and/or combinations thereof. Task specific feedback can include, for example, output indicating whether a robot successfully completed a skill in the environment (e.g., successfully picked up an object, successfully moved to a location, etc.). For example, one or more instances of sensor data, such as one or more instances of vision data captured by one or more vision sensors of the robot, can be processed using a success detection model to generate output indicating whether the robot successfully grasped the object (e.g., generating output indicating the task specific feedback of “not successful” or “successful”). If the robot unsuccessfully attempts to grasp the object, the system can generate the task specific textual feedback of “not successful”. Similarly, if the robot successfully grasps the object, the system can generate the task specific textual feedback of “successful”. In some implementations, task specific feedback can be utilized in accordance with example 400 described herein with respect to FIG. 4A

Passive scene description feedback can broadly describe sources of scene feedback that are consistently provided to the LLM. Additionally or alternatively, passive scene description feedback can have a defined textual structure. In some implementations, passive scene description feedback can include a list of objects in the environment of the robot, such as a list of objects generated by processing one or more instances of vision data capturing the environment of the robot using an object detector model. For example, instance(s) of vision data capturing a table with a can of soda, a candy bar, and a banana can be processed using the object detector. Passive scene description feedback of “soda can, candy bar, banana” can be generated based on the output of the object detector. In some implementations, passive scene description feedback can be provided to the LLM automatically. In some implementations, passive scene description feedback can be utilized in accordance with example 430 described herein with respect to FIG. 4B.

Active scene description feedback can include unstructured textual answers that are provided in response to open ended queries made by the LLM. In some implementations, a human operator can provide the unstructured textual answer. In some other implementations, the unstructured textual answer can be provided by an additional neural network model, such as a Visual Question Answering model. For example, subsequent to the robot successfully completing the action of navigating to a set of drawers, the LLM can ask the question “is the drawer open?”. In some implementations, a human operator, based on one or more instances of vision data capturing the environment of the robot, can provide the answer “The drawer is closed”. In some implementations, active scene description can be utilized in accordance with example 460 described herein with respect to FIG. 4C.

At block 506, the system processes the natural language instruction and the textual feedback using a LLM to generate LLM output. In some implementations, the LLM output is textual output. In some of those implementations, the robot's inner monologue can be generated based on the LLM output.

At block 508, the system selects a robotic skill based on comparing the LLM output with one or more textual skill descriptions. In some implementations, the system has a set of skills the robot can perform, where each skill has (1) a corresponding policy network for use in implementation of the skill and (2) a textual skill description of the skill.

At block 510, the system causes the robot to implement the robotic skill in the environment.

At block 512, the system determines whether to continue performing the task. In some implementations, the system can determine whether to continue performing the task based on whether one or more conditions are satisfied, such as whether the task has been performed, whether a threshold value of time has elapsed, whether a threshold number of computing resources have been used (e.g., processor cycles, memory, etc.), whether one or more additional or alternative conditions are satisfied, and/or combinations thereof. If so, the system proceeds back to block 504, determines updated textual feedback based on processing one or more updated instances of updated sensor data. If not, the process ends.

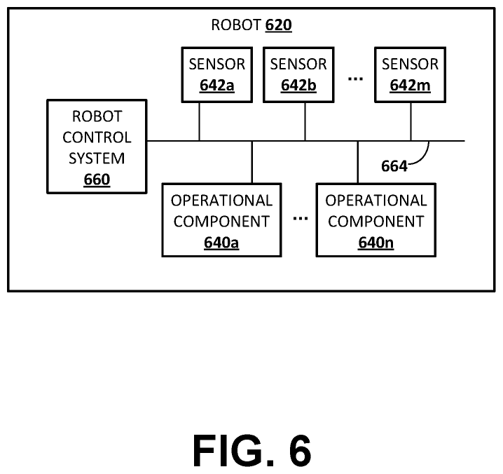

FIG. 6 schematically depicts an example architecture of a robot 620. The robot 620 includes a robot control system 660, one or more operational components 640a-640n, and one or more sensors 642a-642m. The sensors 642a-642m may include, for example, vision sensors, light sensors, pressure sensors, pressure wave sensors (e.g., microphones), proximity sensors, accelerometers, gyroscopes, thermometers, barometers, and so forth. While sensors 642a-m are depicted as being integral with robot 620, this is not meant to be limiting. In some implementations, sensors 642a-m may be located external to robot 620, e.g., as standalone units.

Operational components 640a-640n may include, for example, one or more end effectors and/or one or more servo motors or other actuators to effectuate movement of one or more components of the robot. For example, the robot 620 may have multiple degrees of freedom and each of the actuators may control the actuation of the robot 620 within one or more of the degrees of freedom responsive to the control commands. As used herein, the term actuator encompasses a mechanical or electrical device that creates motion (e.g., a motor), in addition to any driver(s) that may be associated with the actuator and that translate received control commands into one or more signals for driving the actuator. Accordingly, providing a control command to an actuator may comprise providing the control command to a driver that translates the control command into appropriate signals for driving an electrical or mechanical device to create desired motion.

The robot control system 660 may be implemented in one or more processors, such as a CPU, GPU, and/or other controller(s) of the robot 620. In some implementations, the robot 620 may comprise a “brain box” that may include all or aspects of the control system 660. For example, the brain box may provide real time bursts of data to the operational components 640a-n, with each of the real time bursts comprising a set of one or more control commands that dictate, inter alia, the parameters of motion (if any) for each of one or more of the operational components 640a-n. In some implementations, the robot control system 660 may perform one or more aspects of method(s) described herein, such as process 500 of FIG. 5.

As described herein, in some implementations all or aspects of the control commands generated by control system 660, in controlling a robot during performance of a robotic task, can be generated based on robotic skill(s) determined to be relevant for the robotic task and, optionally, based on determined map location(s) for environmental object(s). Although control system 660 is illustrated in FIG. 6 as an integral part of the robot 620, in some implementations, all or aspects of the control system 660 may be implemented in a component that is separate from, but in communication with, robot 620. For example, all or aspects of control system 660 may be implemented on one or more computing devices that are in wired and/or wireless communication with the robot 620, such as computing device 710.

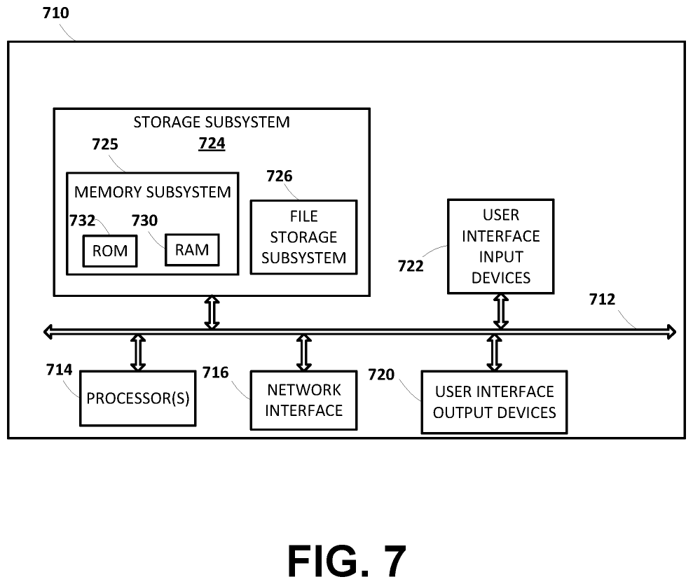

FIG. 7 is a block diagram of an example computing device 710 that may optionally be utilized to perform one or more aspects of techniques described herein. Computing device 710 typically includes at least one processor 714 which communicates with a number of peripheral devices via bus subsystem 712. These peripheral devices may include a storage subsystem 724, including, for example, a memory subsystem 725 and a file storage subsystem 726, user interface output devices 720, user interface input devices 722, and a network interface subsystem 716. The input and output devices allow user interaction with computing device 710. Network interface subsystem 716 provides an interface to outside networks and is coupled to corresponding interface devices in other computing devices.

User interface input devices 722 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 710 or onto a communication network.

User interface output devices 720 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 710 to the user or to another machine or computing device.

Storage subsystem 724 stores programming and data constructs that provide the functionality of some or all of the modules described herein. For example, the storage subsystem 724 may include the logic to perform selected aspects of the method 200 of FIG. 2, the method 300 of FIG. 3, the method 400 of FIG. 4, and/or the method 500 of FIG. 5.

These software modules are generally executed by processor 714 alone or in combination with other processors. Memory 725 used in the storage subsystem 724 can include a number of memories including a main random access memory (RAM) 730 for storage of instructions and data during program execution and a read only memory (ROM) 732 in which fixed instructions are stored. A file storage subsystem 726 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 726 in the storage subsystem 724, or in other machines accessible by the processor(s) 714.

Bus subsystem 712 provides a mechanism for letting the various components and subsystems of computing device 710 communicate with each other as intended. Although bus subsystem 712 is shown schematically as a single bus, alternative implementations of the bus subsystem may use multiple buses.

Computing device 710 can be of varying types including a workstation, server, computing cluster, blade server, server farm, or any other data processing system or computing device. Due to the ever-changing nature of computers and networks, the description of computing device 710 depicted in FIG. 7 is intended only as a specific example for purposes of illustrating some implementations. Many other configurations of computing device 710 are possible having more or fewer components than the computing device depicted in FIG. 7.

In some implementations, a method implemented by one or more processors is provided, the method includes identifying an instruction for a robot to perform a task in an environment, the instruction being a free-form natural language instruction. In some implementations, the method includes determining, based on processing sensor data from one or more sensors of the robot, textual feedback that describes a current state of the environment of the robot. In some implementations, the method includes processing the instruction and the textual feedback using a large language model (LLM) to generate LLM output that is dependent on the instruction and that indicates one or more sub-tasks for performing the task. In some implementations, the method includes identifying a robotic skill that is performable by the robot, and a textual skill description of the robotic skill. In some implementations, the method includes determining, based on comparing the LLM output to the skill description, to implement the robotic skill. In some implementations, in response to determining to implement the robotic skill, the method includes causing the robot to implement the robotic skill in the environment.

These and other implementations of the technology can include one or more of the following features.

In some implementations, subsequent to causing the robot to implement the robotic skill in the environment the method further includes determining, based on processing updated sensor data from the one or more sensors of the robot, updated textual feedback that describes an updated state of the environment of the robot. In some implementations, the method further includes processing the instruction and the updated textual feedback using the LLM to generate updated LLM output. In some implementations, the method further includes identifying an additional robotic skill that is performable by the robot, and an additional textual skill description of the additional robotic skill. In some implementations, the method further includes determining, based on comparing the updated LLM output and the additional textual skill description, to implement the additional robotic skill. In some implementations, in response to determining to implement the additional robotic skill, the method further includes causing the robot to implement the additional robotic skill in the environment.

In some implementations, the textual feedback includes task specific feedback. In some versions of those implementations, the task specific feedback includes an indication of whether the robot successfully implemented a previous robotic skill. In some versions of those implementations, the sensor data from the one or more sensors of the robot includes one or more instances of vision data from one or more vision sensors of the robot. In some versions of those implementations, determining the task specific feedback includes processing the one or more instances of vision data using a success detection model to generate the indication of whether the robot successfully implemented the previous robotic skill. In some versions of those implementations, the sensor data from the one or more sensors of the robot includes one or more instances of force sensor data from one or more force sensors of an end effector of the robot. In some versions of those implementations, determining the task specific feedback includes processing the one or more instances of force sensor data using a success detection model to generate the indication of whether the robot successfully implemented the previous robotic skill.

In some implementations, the textual feedback includes passive scene description feedback. In some versions of those implementations, the passive scene description feedback includes an indication of one or more objects detected in the environment. In some versions of those implementations, the sensor data from the one or more sensors of the robot includes one or more instances of vision data from one or more vision sensors of the robot. In some versions of those implementations, determining the passive scene description feedback includes processing the one or more instances of vision data using an object detection model to generate the indication of the one or more objects detected in the environment.

In some implementations, the textual feedback includes active scene description feedback. In some versions of those implementations, the active scene description feedback includes an unstructured textual answer to an open ended question provided by the LLM. In some versions of those implementations, the unstructured textual answer to the open ended question provided by the LLM is generated based on a response to the open ended question provided by a human operator. In some versions of those implementations, the unstructured textual answer to the open ended question provided by the LLM is generated based on processing the open ended question using a Visual Question Answering model to generate the unstructured textual answer.

In some implementations, the textual feedback includes task specific feedback and passive scene description feedback.

In some implementations, the textual feedback includes task specific feedback and active scene description feedback.

In some implementations, the textual feedback includes passive scene description feedback and active scene description feedback.

In some implementations, the textual feedback includes task specific feedback, passive scene description feedback, and active scene description feedback.

In some implementations, the task is a long-horizon task, and wherein the long-horizon task cannot be implemented, by the robot, in a single robotic skill.

In some implementations, the environment is a simulation.

In some implementations, the environment is a real world environment.

In some implementations, the task is a manipulation task.

In some implementations, the task is a navigation task.

Other implementations can include a non-transitory computer readable storage medium storing instructions executable by one or more processor(s) (e.g., a central processing unit(s) (CPU(s)), graphics processing unit(s) (GPU(s)), and/or tensor processing unit(s) (TPU(s))) to perform a method such as one or more of the methods described herein. Yet other implementations can include a system of one or more computers and/or one or more robots that include one or more processors operable to execute stored instructions to perform a method such as one or more of the methods described herein.

What is claimed is:

1. A method implemented by one or more processors, the method comprising:
identifying an instruction for a robot to perform a task in an environment, the instruction being a free-form natural language instruction;
determining, based on processing sensor data from one or more sensors of the robot, textual feedback that describes a current state of the environment of the robot;
processing the instruction and the textual feedback using a large language model (LLM) to generate LLM output that is dependent on the instruction and that indicates one or more sub-tasks for performing the task;
identifying a robotic skill that is performable by the robot, and a textual skill description of the robotic skill;
determining, based on comparing the LLM output to the skill description, to implement the robotic skill; and
in response to determining to implement the robotic skill:
causing the robot to implement the robotic skill in the environment.

2. The method of claim 1, subsequent to causing the robot to implement the robotic skill in the environment and further comprising:
determining, based on processing updated sensor data from the one or more sensors of the robot, updated textual feedback that describes an updated state of the environment of the robot;
processing the instruction and the updated textual feedback using the LLM to generate updated LLM output;
identifying an additional robotic skill that is performable by the robot, and an additional textual skill description of the additional robotic skill;
determining, based on comparing the updated LLM output and the additional textual skill description, to implement the additional robotic skill; and
in response to determining to implement the additional robotic skill:
causing the robot to implement the additional robotic skill in the environment.

3. The method of claim 1, wherein the textual feedback includes task specific feedback.

4. The method of claim 3, wherein the task specific feedback includes an indication of whether the robot successfully implemented a previous robotic skill.

5. The method of claim 4, wherein the sensor data from the one or more sensors of the robot includes one or more instances of vision data from one or more vision sensors of the robot, and wherein determining the task specific feedback comprises:
processing the one or more instances of vision data using a success detection model to generate the indication of whether the robot successfully implemented the previous robotic skill.

6. The method of claim 4, wherein the sensor data from the one or more sensors of the robot includes one or more instances of force sensor data from one or more force sensors of an end effector of the robot, and wherein determining the task specific feedback comprises:
processing the one or more instances of force sensor data using a success detection model to generate the indication of whether the robot successfully implemented the previous robotic skill.

7. The method of claim 1, wherein the textual feedback includes passive scene description feedback.

8. The method of claim 7, wherein the passive scene description feedback includes an indication of one or more objects detected in the environment.

9. The method of claim 8, wherein the sensor data from the one or more sensors of the robot includes one or more instances of vision data from one or more vision sensors of the robot, and wherein determining the passive scene description feedback comprises:
processing the one or more instances of vision data using an object detection model to generate the indication of the one or more objects detected in the environment.

10. The method of claim 1, wherein the textual feedback includes active scene description feedback.

11. The method of claim 10, wherein the active scene description feedback includes an unstructured textual answer to an open ended question provided by the LLM.

12. The method of claim 11, wherein the unstructured textual answer to the open ended question provided by the LLM is generated based on a response to the open ended question provided by a human operator.

13. The method of claim 11, wherein the unstructured textual answer to the open ended question provided by the LLM is generated based on processing the open ended question using a Visual Question Answering model to generate the unstructured textual answer.

14. The method of claim 1, wherein the textual feedback includes task specific feedback and passive scene description feedback.

15. The method of claim 1, wherein the textual feedback includes task specific feedback and active scene description feedback.

16. The method of claim 1, wherein the textual feedback includes passive scene description feedback and active scene description feedback.

17. The method of claim 1, wherein the textual feedback includes task specific feedback, passive scene description feedback, and active scene description feedback.

18. The method of claim 1, wherein the task is a long-horizon task, and wherein the long-horizon task cannot be implemented, by the robot, in a single robotic skill.

19. The method of claim 1, wherein the environment is a simulation.

20. The method of claim 1, wherein the environment is a real world environment.

21. The method of claim 1, wherein the task is a manipulation task.

22. The method of claim 1, wherein the task is a navigation task.
